(19) United States
(12) Patent Application Publication
(10) Pub. No.: US 2026/0339553 A1
(43) Pub. Date: Oct. 29, 2026

(54) STORAGE FOR COMPUTING SYSTEMS

(71) Applicant: Dell Products L.P., Round Rock, TX (US)

(72) Inventors: Yurun Wu, Shanghai (CN); Xiao Le Shang, Shanghai (CN); Jiang Cao, Shanghai (CN)

(21) Appl. No.: 19/228,581

(22) Filed: Jun. 4, 2025

(30) Foreign Application Priority Data
Apr. 25, 2025 (CN) 202510536892.5

(51) Int. Cl. G06F 3/06

(52) U.S. Cl. CPC G06F 3/0659; G06F 3/0604; G06F 3/067

(57) ABSTRACT

The subject technologies relate to storage in computing systems. An example method includes receiving a target request from a target application. The method further includes routing the target request to a target storage instance by performing a second routing on the target request at a target computing node, where the target storage instance corresponds to a sub shard in a logical shard hosted by the target computing node. In addition, the method further includes executing a storage operation corresponding to the target request at the target storage instance. Thus, with embodiments of the present disclosure, it is possible to further route requests from applications at a computing node to the sub shard in a logical shard hosted by the node while maintaining schedule of the storage system by logical shards, facilitating on-demand configuration or expansion of storage resources and achieving decoupling between computing resources and storage resources.

### RELATED APPLICATION

The present application claims the benefit of priority to Chinese Patent Application No. 202510536892.5, filed on Apr. 25, 2025, which application is hereby incorporated into the present application by reference herein in its entirety.

### TECHNICAL FIELD

Example embodiments of the present disclosure relate to the field of computers, and, for example, to a method, a device, and a computer program product for storage in computing systems.

### BACKGROUND

With the development of information technology, data has become the core resource for the operation of enterprises and society. As a critical infrastructure for data management, storage, and access, the importance of databases is becoming increasingly prominent. From early relational databases to today's diverse non-relational and distributed database systems, database technologies continue to evolve, supporting efficient processing and intelligent applications of massive amounts of data.

### SUMMARY

Example embodiments of the present disclosure provide a method, a device, and a computer program product for storage.

According to an example embodiment of the present disclosure, a method for storage is provided. The method includes receiving a target request from a target application, where the target request is determined, at the target application through a first routing, to be routed to a target computing node in multiple computing nodes on a storage system, and each computing node in the multiple computing nodes hosts a corresponding logical shard. The method further includes routing the target request to a target storage instance by performing a second routing on the target request at the target computing node, where the target storage instance corresponds to a sub shard in the logical shard hosted by the target computing node. In addition, the method further includes executing a storage operation corresponding to the target request at the target storage instance.

According to another example embodiment of the present disclosure, an electronic device is provided. The device includes a processing unit and a memory, where the memory is coupled to the processing unit and stores instructions. The instructions perform the following actions when executed by a processing unit: receiving a target request from a target application, where the target request is determined, at the target application through a first routing, to be routed to a target computing node in multiple computing nodes on a storage system, and each computing node in the multiple computing nodes hosts a corresponding logical shard; routing the target request to a target storage instance by performing a second routing on the target request at the target computing node, where the target storage instance corresponds to a sub shard in the logical shard hosted by the target computing node; and executing a storage operation corresponding to the target request at the target storage instance.

According to still another example embodiment of the present disclosure, a computer program product is provided. The computer program product is tangibly stored on a non-transitory computer-readable medium and includes computer-executable instructions. The computer-executable instructions, when executed, cause a computer to perform the method or process according to the embodiments of the present disclosure.

This Summary is provided to introduce a selection of concepts in a simplified manner and will be further described in the following detailed description. This Summary is neither intended to identify key features or main features of the present disclosure, nor intended to limit the scope of the embodiments of the present disclosure.

### BRIEF DESCRIPTION OF THE DRAWINGS

By describing the example embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 shows a schematic diagram of an example environment in which a device and/or a method according to an embodiment of the present disclosure can be implemented;

FIG. 2 shows a flow chart of a method for storage according to an embodiment of the present disclosure;

FIG. 3 shows a schematic diagram of an architecture of a key-value store system according to an embodiment of the present disclosure;

FIG. 4 shows a schematic diagram of a process for executing an atomic batch operation according to an embodiment of the present disclosure;

FIG. 5 shows a schematic diagram of an on-the-fly scaling process according to an embodiment of the present disclosure; and

FIG. 6 shows a schematic block diagram of a device that can be used to implement an embodiment of the present disclosure.

In various accompanying drawings, identical or corresponding reference numerals represent identical or corresponding parts.

### DETAILED DESCRIPTION

Preferred embodiments of the present disclosure will be described in further detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided such that the present disclosure is more thorough and complete, and the scope of the present disclosure can be fully conveyed to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

As stated above, with the development of information technology, the storage system has become increasingly important. In related technologies, a storage system typically divides a key space into multiple shards and maps the shards to different computing nodes through consistent hashing or other partitioning processes. Each computing node is not only responsible for processing requests on the shard, but also bound to a corresponding bottom layer storage structure. Under this architecture, computing resources and storage resources form a tightly coupled relationship within the system, resulting in the need to simultaneously add computing nodes and the storage structures they are bound to during the system expansion process. It is impossible to expand separately for computing or storage, especially when dealing with complex or non-uniform load scenarios, where expansion flexibility is limited and resource utilization efficiency is not high.

Regarding this, the present disclosure provides a technical solution for storage, which achieves decoupling between the computing node and storage resources by introducing a two round routing mechanism. In the solution, a target request is first received from a target application. The request is determined to be routed to a target computing node through a first round of routing, and each computing node hosts a corresponding logical shard. After the target computing node receives the request, a second round of routing is executed to further route the request to a target storage instance corresponding to a certain sub shard inside the logical shard, and then specific operations corresponding to the request are executed at the target storage instance.

Thus, with embodiments of the present disclosure, it is possible to further route requests from applications at a computing node to the sub shard in a logical shard hosted by the node while maintaining schedule of the storage system by logical shards, facilitating on-demand configuration or expansion of storage resources and achieving decoupling between computing resources and storage resources.

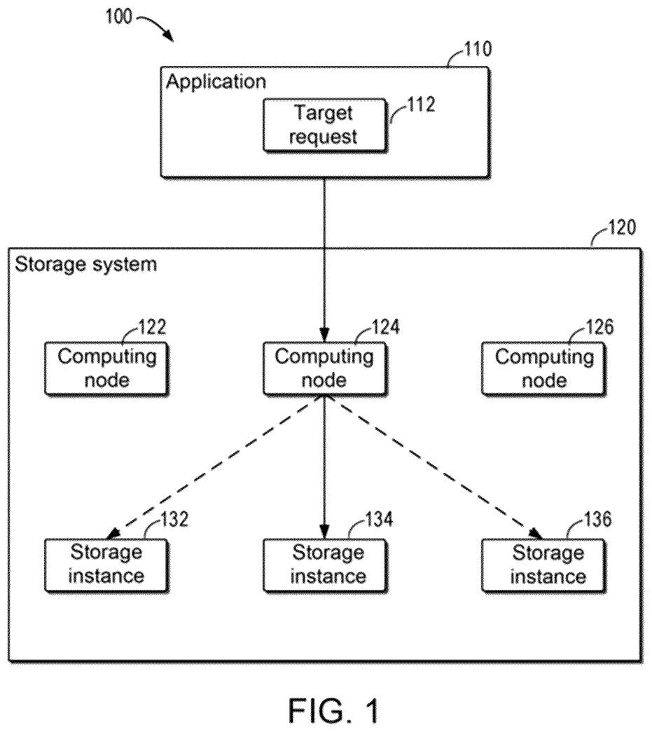

The basic principles and several example implementations of the present disclosure are described below with reference to FIG. 1 to FIG. 6. It should be understood that these example embodiments are given only to enable those skilled in the art to better understand and thus implement the embodiments of the present disclosure, and are not intended to limit the scope of the present disclosure in any way.

FIG. 1 shows an example environment 100 in which a device and/or a method according to an embodiment of the present disclosure can be implemented. As shown in FIG. 1, the example environment 100 can include an application 110. In some embodiments, the application 110 has the ability of initiating storage requests on a client-side service system of a storage system 120, such as e-commerce trading systems, social media platforms, or log analysis tools. It should be understood that the target request can include, but is not limited to, read requests, write requests, update requests, and so on. The example environment 100 can also include a storage system 120. In some embodiments, the storage system 120 can be a key-value store (KV Store) system. The key-value store system is a database that stores data in the form of key-value pairs. It has a simple structure and efficient access, and is widely used in high-performance and distributed systems. Common key-value store systems include Redis, LevelDB/RocksDB, TiKV, and DynamoDB, and are suitable for various scenarios such as caching, state management, and metadata storage. The client of the storage system 120 can be installed at the application 110 and is used to receive requests from the application 110 and send the requests.

The storage system 120 can receive a target request 112 from the application 110. The request is determined to be sent to the target computing node (for example, a computing node 124) in the multiple computing nodes on the storage system 120 through the first round of routing at the application 110. For example, the storage system 120 can include a computing node 122, a computing node 124, and a computing node 126. In some embodiments, each computing node in the storage system 120 can host a corresponding logical shard and is responsible for processing requests in a range of this shard. For example, in the scenario of e-commerce trading systems, the application 110 can initiate a write request for updating user information, and the request includes a key “user: 12345.” The storage system client deployed at the application 110 can use a consistent hashing process or other partitioning rules based on the key to map the request to a logical shard in the key value space and determine that the shard is hosted by the computing node 124. Subsequently, the target request 112 will be sent to the computing node 124.

The storage system 120 can route the target request to a corresponding storage instance by performing a second round of routing on the target request 112 at the computing node 124. For example, after the first round of routing, a write request has been sent to the computing node 124. After receiving the request, the computing node 124 can perform hash computing on the key again based on a second round of routing rule defined by the application 110, and map the request to one of multiple storage instances. For example, the computing node 130 maintains three storage instances, that is, a storage instance 132, a storage instance 134, and a storage instance 136. The logical shard hosted by the computing node 130 is divided into multiple sub shards, and each storage instance respectively corresponds to one sub shard. In some embodiments, the storage instance can be dynamically constructed based on a storage resource pool. The storage resource pool can include but is not limited to bottom layer resources such as physical disks, distributed block storage, or object storage.

In some embodiments, the storage instance can adopt different types of storage structures, such as a B+ tree structure suitable for range queries, an LSM tree structure suitable for high write throughput, or a hash table structure suitable for fast key value access, to support diverse data access modes and performance requirements. The storage system 120 can determine, based on the hash value of the key, that it should be routed to one of the specific storage instances (such as the storage instance 134) to complete the storage operation corresponding to the request. In some embodiments, storage operations can include various types such as read, write, update, delete, etc. For example, the read operation can be used to acquire data associated with a specified key from the target storage instance, the write operation can write the specified key-value pair to the storage instance, and the delete operation is used to remove a key-value pair from the storage instance.

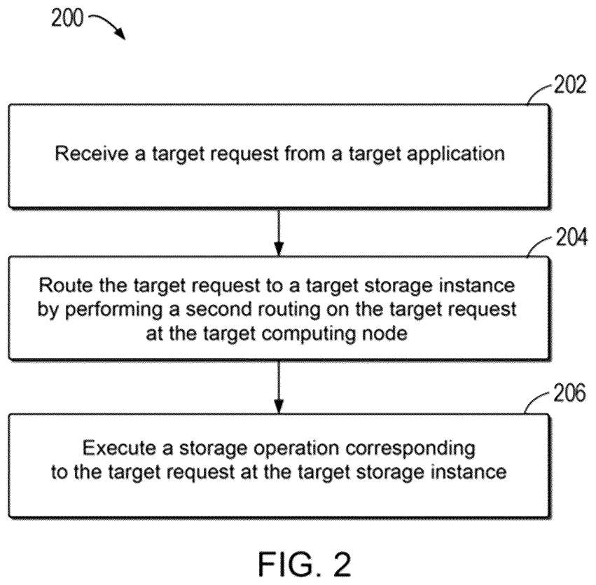

It should be understood that the architecture and functions in the example environment 100 are described only for illustrative purposes, without implying any limitation to the scope of the present disclosure. The embodiments of the present disclosure may also be applied to other environments having different structures and/or functions. A process according to the embodiments of the present disclosure will be described in detail below with reference to FIG. 2 to FIG. 6. For ease of understanding, specific data mentioned in the following description are all examples and are not intended to limit the scope of protection of the present disclosure. It should be understood that the embodiments described below may also include additional actions not shown and/or may omit actions shown, and the scope of the present disclosure is not limited in this regard.

FIG. 2 shows a flow chart of a method 200 for storage according to an embodiment of the present disclosure. At a block 202, a target request from a target application can be received, where the target request is determined, at the target application through a first routing, to be routed to a target computing node in multiple computing nodes on a storage system, and each computing node in the multiple computing nodes hosts a corresponding logical shard. For example, describing with reference to FIG. 1, the storage system 120 can receive a target request 112 from an application 110, where the target request 112 is determined, at the application 110 through the first routing, to be routed to a computing node 124 in the multiple computing nodes on a storage system 120, and each computing node in the multiple computing nodes hosts a corresponding logical shard.

At a block 204, the target request can be routed to a target storage instance by performing a second routing on the target request at the target computing node, where the target storage instance corresponds to a sub shard in the logical shard hosted by the target computing node. For example, describing with reference to FIG. 1, the storage system 120 can route the target request 112 to a storage instance 134 by performing a second routing on the target request 112 at the computing node 124, where the storage instance 134 corresponds to a sub shard in the logical shard hosted by the computing node 124.

At a block 206, a storage operation corresponding to the target request can be executed at the target storage instance. For example, describing with reference to FIG. 1, the storage system 120 can execute a storage operation corresponding to the target request 112 at the storage instance 134. Hence, with the method 200 according to an embodiment of the present disclosure, it is possible to further route requests from applications at the computing node to sub shards in the logical shard hosted by the node while maintaining schedule of the storage system by logical shards, facilitating on-demand configuration or expansion of storage resources and achieving decoupling between computing resources and storage resources.

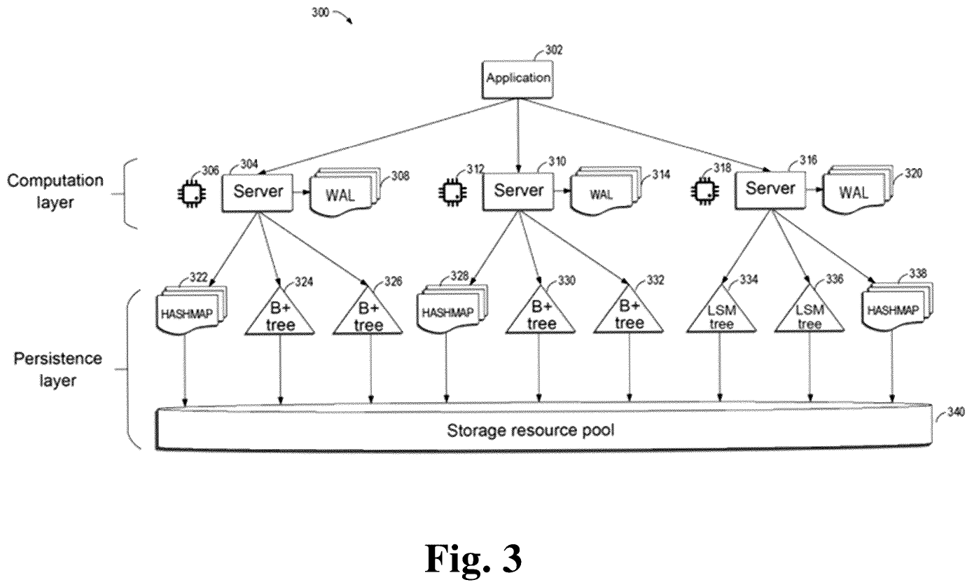

FIG. 3 shows a schematic diagram of an architecture 300 of a key-value store system according to an embodiment of the present disclosure. As stated above, the key-value store system is a database that stores data in the form of key-value pairs. It has a simple structure and efficient access, and is widely used in high-performance and distributed systems. Common key-value store systems include Redis, LevelDB/RocksDB, TiKV, and DynamoDB, and are suitable for various scenarios such as caching, state management, and metadata storage. As shown in FIG. 3, at an application 302, a first round of routing can be performed for requests of the key-value store system. The key-value store system includes a client configured at the application, a computing layer consisting of multiple servers, and a persistence layer consisting of storage resources. The application 302 can be a service system deployed on the client-side of a key-value store system, such as an e-commerce trading system, social media platforms, or log analysis tools, with the ability to initiate and schedule key-value access requests. In some embodiments, the application 302 can perform the first round of routing on the request based on the key fields in the request through the client in the integrated key-value store system. The requests from an application can include the content of keys and values, where the keys are used to uniquely identify the target data and values represent the data content associated with the keys. The types of requests can include query requests (such as get) and update requests (such as put or delete).

In some embodiments, the client of the key-value store system can acquire key fields in the request, and then route the request to the computing node of the storage system by using a consistent hashing process based on the key field. For example, when the first round of routing is executed, the storage system client at the application 302 calculates its position in a hash ring based on the key field in the request, and selects a corresponding server (i.e., the computing node) for processing based on the hash result. For example, the key “user: 12345” is mapped to a server 304 of a computing layer after consistent hash calculation, and the request will be sent to the server, which is responsible for the subsequent processing flow.

As shown in FIG. 3, the computation layer of the key-value store system can include multiple servers for processing requests from applications. For example, the computation layer can include a server 304, a server 310, and a server 316. It should be understood that the three servers shown here are for illustrative purposes only, and the embodiments of the present disclosure do not limit the number of servers in the key-value store system. Each server can host its corresponding logical shard. Each server in the computing layer is deployed with a processor CPU, such as CPU 306, CPU 312, and CPU 318 shown in the figure, for executing computing tasks related to key value requests.

In some embodiments, after receiving a request from an application, the server can extract the key fields in the request and obtain a routing rule used to execute the second round of routing. The routing rule can be defined by the application during a deployment phase (e.g., defined by an application developer) and maintained at the server side. It should be understood that the routing rule of the second routing maintained at each server can be the same or different. On such basis, the server further routes the request to the corresponding storage instance based on the key field and the routing rule maintained. For example, when the first round of routing sends a request to the server 310, the server 310 can search for the second round of routing rule stored locally, calculate the key fields in the request accordingly, and distribute the request to a target storage instance managed by it.

It should be understood that from the perspective of the application layer, applications can only route requests to the logical shard corresponding to the server based on key fields, that is, they can only perform the first round of routing. Applications typically do not have detailed information about the internal structure of the server, such as the second round of routing rule used by the server or the specific division of the storage instances managed. Therefore, the processing of the second round of routing is completed at the server side, which the application does not directly participate in. From a logical structure perspective, each server further divides its hosted logical shard into multiple sub shards based on the second round of routing rule, and maps these sub shards to different storage instances, respectively, thereby achieving decoupling between the computation layer and the persistence layer.

In some embodiments, each server can be configured with Write-Ahead Logging or write ahead log (WAL), such as WAL 308, WAL 314, and WAL 320 in FIG. 3. The WAL is used to sequentially record the received request content before performing persistence operations, ensuring that the system has data recovery capabilities in abnormal situations and supports atomicity of operations. For example, when the server 310 processes a request, it first writes the key value operation corresponding to the request into the WAL 314. After the WAL is successfully written, the operation is then applied to the corresponding storage instance. In some embodiments, the WAL is shared by multiple storage instances managed by the server, i.e., the WAL is shared by the sub shards managed by the server. For example, the WAL 314 is a shared WAL shared by a storage instance 328, a storage instance 330, and a storage instance 332. It should be understood that the three storage instances shown here are for illustrative purposes only, and the embodiments of the present disclosure do not limit the number of storage instances managed by each server.

In some embodiments, each server can be configured with a memory table MemTable for storing key-value pair data. The MemTable is used to temporarily store the key value pairs corresponding to the requests after writing the key-value requests into the WAL and before writing them into the corresponding storage instances, in order to achieve fast access to data and batch write control. For example, when the server 310 receives a write request and completes the WAL write operation, it will write the corresponding key-value data to the local MemTable. Subsequent read requests can directly hit data from the MemTable, thereby avoiding frequent access to a bottom layer storage structure and improving system response efficiency. In some embodiments, the MemTable can be constructed in the main memory (e.g., RAM) of a server and shared by multiple storage instances managed by the server, i.e., the MemTable is shared by the sub shards managed by the server. For example, the MemTable in the memory of the server 310 is a shared WAL shared by the storage instance 328, the storage instance 330, and the storage instance 332.

In some embodiments, when the request from the application is a write request, the target data in the request can be written to the shared WAL, and the storage instance to which the request is to be routed can be recorded in the shared WAL. For example, when a request is routed to the server 310, the server 310 may first write the key-value pair in the request into the WAL 314 and attach information indicating the target storage instance in the log, for example, the request should ultimately be written to one of the storage instance 328, the storage instance 330, or the storage instance 332. By writing the routing information of the target storage instance (i.e., the routing information of the second round of routing) along with key value data into the shared WAL, the system can fully recover the MemTable content and a mapping relationship of its corresponding storage instance through the WAL in the event of a failure, thereby avoiding data errors during the recovery process caused by the loss of routing information.

In some embodiments, when data is written into a shared WAL, the target data can be written into a shared MemTable, and when the shared MemTable reaches a reserved storage size, a dumping operation is performed. The dumping operation is used to write to-be-dumped data in the shared MemTable into the corresponding the storage instance maintained by the target computing node. For example, after the request is routed to the server 310 and the writing of WAL 314 is completed, the key value pair data will be written to the shared MemTable corresponding to the server. When the data volume of the MemTable reaches a set threshold, the server 310 will perform a dumping operation on the data in the MemTable, and respectively write the data into the corresponding positions in the storage instance 328, the storage instance 330, and the storage instance 332.

In some embodiments, the server can determine, based on the routing rule used for performing the second round of routing, a storage instance into which the to-be-dumped data in the shared MemTable will be written, and dump the to-be-dumped data into the corresponding storage instance in parallel. For example, the server can determine the target storage instance corresponding to each key-value pair data and perform the dumping operation in parallel after dividing these data according to the target storage instances. For example, at the server 310, for the key value data in the MemTable, the server 310 can perform calculations on the key fields according to the hash process defined by the application, and based on this, dump some data to the storage instance 328, some data to the storage instance 330, and the remaining data to the storage instance 332. The above multiple dumping tasks can be executed simultaneously in parallel, which can fully utilize the concurrency capability of multiple storage instances, help improve overall write performance, and enhance the processing capacity of the storage system.

As shown in FIG. 3, the persistence layer of the key value store system can include multiple storage instances, which are used to persistently store write requests from the computing layer. In some embodiments, each server can include multiple types of storage structures, which can be deployed according to the actual workload. For example, each server can include one or more HashMap structures, one or more B+tree structures, and one or more LSM tree structures to adapt to different data access modes and performance requirements. For example, the server 304 can maintain the storage instance 322 of the HashMap structure and the storage instances 324 and 326 of the B+ tree structure; the server 310 can maintain the storage instance 328 of the HashMap structure and the storage instances 330 and 332 of the B+ tree structure; and the server 316 can maintain the storage instances 334 and 336 of the LSM tree structure and the storage instance 338 of the HashMap structure. Each storage instance is used to respectively store key value pair data in different sub shards and is connected to a unified storage resource pool 340 from the bottom layer. The storage resource pool 340 can be a physical disk, distributed block storage, or an object storage system, and is used to persist data in all the storage instances.

By introducing multiple types of storage structures on the same server and deploying them as corresponding storage instances for sub shards under the logical shards, the system can flexibly choose appropriate data structures according to different application scenarios, avoiding the limitation of traditional architectures where each server can only use a single data structure. For example, for data that is frequently updated but does not require sequential access, a HashMap structure can be used; for scenarios that require efficient range queries, a B+ tree structure can be used; while in scenarios with high write pressure, an LSM tree structure can be used to improve write efficiency.

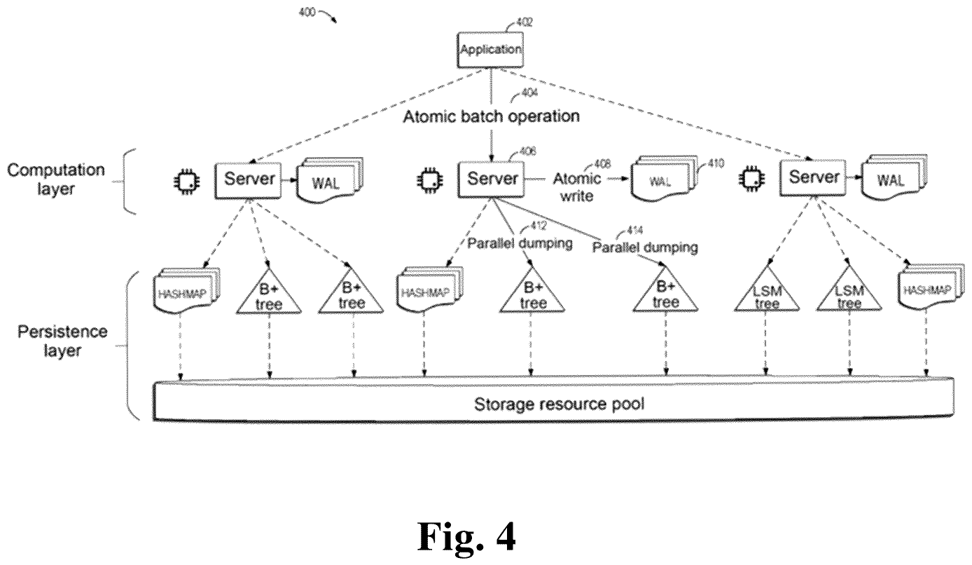

FIG. 4 shows a schematic diagram of a process 400 for executing an atomic batch operation according to an embodiment of the present disclosure. As shown in FIG. 4, an application 402 can initiate an atomic batch request containing an atomic batch operation 404, which is used to perform update operations on multiple keys simultaneously. The atomic batch request can be sent to the same computing node through a first round of routing, such as a server 406 shown in FIG. 4, so as to ensure the atomicity of its subsequent operations. After receiving the atomic batch request, the server 406 first performs atomic write 408 on the batch request, that is, writes the atomic batch operation 404 in batches into a shared WAL 410 as an atomic write operation. In this operation, all key value pairs to be updated are either successfully written to the WAL or fail, ensuring atomicity at the log level.

Subsequently, the server 406 writes the batch request into a shared MemTable in batches. In the background, the server 406 may perform a hash calculation on each key value in the MemTable based on the second-round routing rule defined by the application to determine its corresponding target storage instance. Subsequently, the server 406 can perform dumping operations 412 and 414 in parallel, and respectively dump data from different sub shards into their corresponding B+ tree structures. In this way, the key-value store system can efficiently process the atomic batch request through parallel dumping while ensuring atomicity.

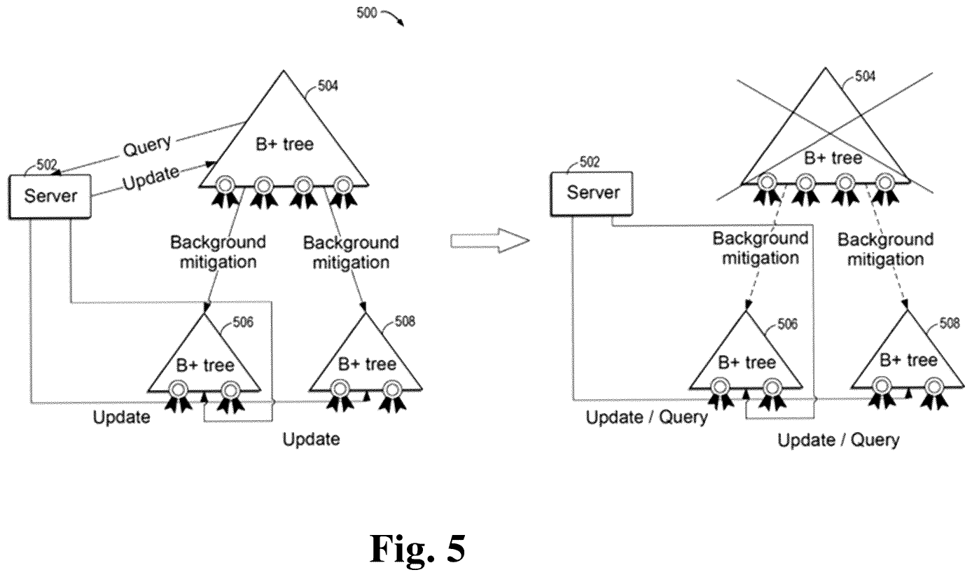

FIG. 5 shows a schematic diagram of an on-the-fly scaling process 500 according to an embodiment of the present disclosure. As shown in FIG. 5, to achieve on-the-fly scaling of a persistence layer, a key value store system can split an original storage instance and migrate its data to a newly created storage instance without stopping the service. For example, taking an original B+ tree structure as an example, the left side of FIG. 5 shows a server 502, which maintains an original B+ tree 504 containing multiple hash ring tokens. This structure corresponds to a certain sub shard and is responsible for processing query and update requests on that sub shard. As the load increases, the sub shard can be further divided to expand storage capacity. It should be understood that the storage structure of the B+ tree is for illustrative purposes only, and the embodiments of the present disclosure do not limit the types of storage structures to be expanded.

In some embodiments, when a storage instance maintained by a server needs to be expanded, multiple newly created storage instances can be initialized, which have the same type of storage structure as the original storage instance. For example, to expand the storage capacity, the server 502 can initialize two newly created B+ tree structures, i.e., a B+ tree 506 and a B+ tree 508, based on the routing rule used by a second round of routing (e.g., a hash process defined by the application). These newly created B+ trees are allocated with a portion of the hash ring tokens from the original B+ tree 504. Subsequently, the server can start a traversing tool in the background to scan all key value pairs in the original B+ tree 504, and migrate the data to the corresponding newly created B+ tree structure based on the tokens held by the new tree, achieving background migration.

After the background migration starts, to ensure data consistency, the system will also perform the dual write operation: that is, during the period that the migration is incomplete, for newly received update requests, their corresponding key value pairs will be written to both the original B+ tree 504 and the target new B+ tree (506 or 508) simultaneously. Meanwhile, the system still responds to all query requests by the original B+ tree 504, ensuring consistency in external service behaviors during migration. When all key value data is successfully migrated to the newly created B+ tree structure and consistency verification is completed, the system will switch between query and update paths, using only the new B+ tree structure to provide services, while the original B+ tree structure can be removed. The right side of FIG. 5 shows the state after the migration is completed. The original B+ tree 504 no longer participates in read and write operations, and a new B+ tree takes over the processing tasks of the corresponding sub shards, achieving completion of the expansion of the storage instance by the computing node without interrupting services.

The above on-the-fly scaling process can independently expand the storage structure, thanks to the two round routing mechanism provided by the embodiments of the present disclosure. In the mechanism, each server not only receives requests within the range of a shard based on the first round of routing, but also further divides the logical shard into multiple sub shards based on the second round hashing process defined by the application, and respectively maps data from different sub shards to their corresponding storage instances. Since the mapping relationship is maintained locally by the server and can be dynamically adjusted, the system only needs to update the second round of routing rule when expanding the storage instance, without changing the mapping relationship between the server and the logical shard under the first round of routing.

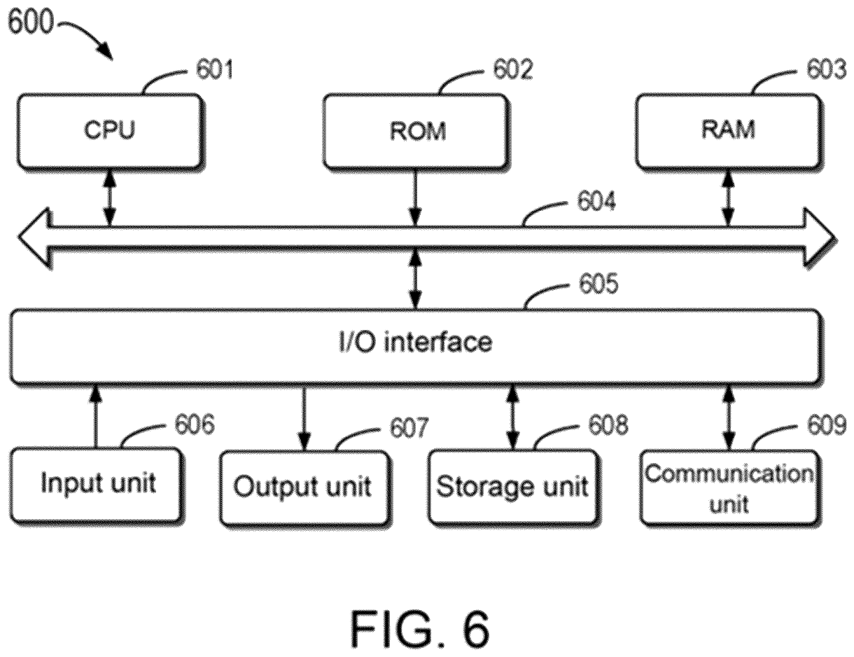

FIG. 6 shows a schematic block diagram of a device 600 that may be configured to implement an embodiment of the present disclosure. The device 600 may be a device or an apparatus as described in the embodiments of the present disclosure. As shown in FIG. 6, the device 600 includes a central processing unit (CPU) 601 that may perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The CPU 601, the ROM 602, and the RAM 603 are connected to each other through a bus 604. An input/output (I/O) interface 605 is also connected to the bus 604.

Multiple components in device 600 are connected to I/O interface 605, including: input unit 606, such as a keyboard or a mouse; output unit 607, such as various types of displays or speakers; the storage unit 608, such as a magnetic disk or an optical disc; and communication unit 609, such as a network card, a modem, or a wireless communication transceiver. The communication unit 609 allows the device 600 to exchange information/data with other devices via a computer network, such as the Internet, and/or various telecommunication networks.

The various methods or processes described above may be performed by the processing unit 601. For example, in some embodiments, the methods may be implemented as a computer software program that is tangibly included in a machine-readable medium such as the storage unit 608. In some embodiments, part of or all the computer program can be loaded and/or installed onto the device 600 via the ROM 602 and/or the communication unit 609. When the computer program is loaded onto the RAM 603 and executed by the CPU 601, one or more steps or actions of the methods or processes described above may be performed.

In some embodiments, the methods and processes described above may be implemented as a computer program product. The computer program product may include a computer-readable storage medium on which computer-readable program instructions for performing various example embodiments of the present disclosure are loaded.

The computer-readable storage medium may be a tangible device that can retain and store instructions for use by an instruction execution device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device such as a punch card or protrusions in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, for example, a programmable logic circuit, a field-programmable gate array (FPGA), or a programmable logic array (PLA), is customized by utilizing state information of the computer-readable program instructions. The electronic circuit may execute the computer-readable program instructions so as to implement various example embodiments of the present disclosure.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flow charts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flow charts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flow charts and/or block diagrams.

The flow charts and block diagrams in the accompanying drawings show the architectures, functionalities, and operations of possible implementations of the device, the method, and the computer program product according to a plurality of embodiments of the present disclosure. In this regard, each block in the flow charts or block diagrams may represent a module, a program segment, or part of instructions, which contains one or more executable instructions for implementing specified logical functions. In some alternative implementations, the functions noted in the blocks may also occur in an order different from that noted in the accompanying drawings. For example, two consecutive blocks may in fact be executed substantially concurrently, and sometimes they may also be executed in the reverse order, depending on the functions involved. It should also be noted that each block in the block diagrams and/or flow charts and combinations of blocks in the block diagrams and/or flow charts can be implemented with a dedicated hardware-based system that performs specified functions or actions, or with a combination of dedicated hardware and computer instructions.

Various embodiments of the present disclosure have been described above. The foregoing description is illustrative rather than exhaustive, and is not limited to the disclosed embodiments. Many modifications and variations will be apparent to those skilled in the art without departing from the scope and spirit of the illustrated various embodiments. The selection of terms as used herein is intended to best explain the principles and practical applications of the various embodiments or the technical improvements to technologies on the market, or to enable other persons of ordinary skill in the art to understand the embodiments disclosed here.

1. A method, comprising:
receiving, by a system comprising at least one processor, a target request from a target application, wherein the target request is determined, at the target application through a first routing, to be routed to a target computing node in multiple computing nodes on a storage system, and each computing node in the multiple computing nodes hosts a corresponding logical shard;
routing, by the system, the target request to a target storage instance by performing a second routing on the target request at the target computing node, wherein the target storage instance corresponds to a sub shard in the logical shard hosted by the target computing node;
executing, by the system, a storage operation corresponding to the target request at the target storage instance; and
in response to determining that an original storage instance maintained by a computing node in the multiple computing nodes will be expanded,
initializing, by the system, multiple newly created storage instances, wherein the multiple newly created storage instances have a same type of storage structure as the original storage instance,
migrating, by the system by traversing key-value pairs in the original storage instance, the key-value pairs to the multiple newly created storage instances,
during the migration, executing, by the system, a dual-write operation on the written key-value pairs, and
in response to determining that the migration has ended, switching, by the system, the computing node from maintaining the original storage instance to maintaining the multiple newly created storage instances.

2. The method of claim 1, wherein the storage system is a key-value store system, and wherein the target request being determined, at the target application through the first routing, to be routed to the target computing node comprises:
acquiring, by the system via the storage system from the target application, a target key in the target request; and
routing, by the system via the storage system using a consistent hashing process based on the target key, the target request to the target computing node in the multiple computing nodes.

3. The method of claim 1, wherein the storage system is a key-value store system, and wherein routing the target request to the target storage instance comprises:
acquiring a target key in the target request,
acquiring, at the target computing node, a routing rule used for performing the second routing, wherein the routing rule is defined by the target application, and
routing, based on the target key at the target computing node, the target request to the target storage instance by means of the routing rule.

4. The method of claim 1, wherein the target computing node maintains a shared write ahead log (WAL) and a shared memory table shared by sub shards in the hosted logical shard.

5. The method of claim 4, further comprising:
in response to determining that the target request is a write request,
writing, by the system, target data in the target request into the shared WAL, and
recording, by the system into the shared WAL, the target storage instance to which the target request is to be routed.

6. The method of claim 5, further comprising:
in response to determining that the target data is written into the shared WAL, writing, by the system, the target data into the shared memory table; and
in response to determining that the shared memory table reaches a reserved storage size, executing, by the system, a dumping operation, wherein the dumping operation is configured to write to-be-dumped data in the shared memory table into a corresponding storage instance maintained by the target computing node.

7. The method of claim 6, further comprising:
determining, by the system based on the routing rule used for performance of the second routing, a storage instance into which the to-be-dumped data in the shared memory table will be written; and
dumping, by the system, the to-be-dumped data into the corresponding storage instance in parallel.

8. The method of claim 4, further comprising:
in response to determining that the target request is an atomic batch request,
writing, by the system, the atomic batch request into the shared WAL in batches, and
in response to determining that the atomic batch request is written into the shared WAL, writing, by the system, the atomic batch request in batches into the shared memory table.

9. (canceled)

10. A device, comprising:
at least one processing unit; and
at least one memory coupled to the at least one processing unit and having instructions stored therein, wherein the instructions, when executed by the at least one processing unit, execute the following actions:
receiving a target request from a target application, wherein the target request is determined, at the target application through a first routing, to be routed to a target computing node in multiple computing nodes on a storage system, and each computing node in the multiple computing nodes hosts a corresponding logical shard;
routing the target request to a target storage instance by performing a second routing on the target request at the target computing node, wherein the target storage instance corresponds to a sub shard in the logical shard hosted by the target computing node;
executing a storage operation corresponding to the target request at the target storage instance; and
in response to determining that an original storage instance maintained by a computing node in the multiple computing nodes will be expanded,
initializing multiple newly created storage instances, wherein the multiple newly created storage instances have a same type of storage structure as the original storage instance,
migrating, by traversing key-value pairs in the original storage instance, the key-value pairs to the multiple newly created storage instances,
during the migration, executing a dual-write operation on the written key-value pairs, and
in response to determining that the migration has ended, switching the computing node from maintaining the original storage instance to maintaining the multiple newly created storage instances.

11. The device of claim 10, wherein the storage system is a key-value store system, and wherein the target request being determined, at the target application through the first routing, to be routed to the target computing node comprises:
acquiring, via the storage system from the target application, a target key in the target request, and
routing, via the storage system using a consistent hashing process based on the target key, the target request to the target computing node in the multiple computing nodes.

12. The device of claim 10, wherein the storage system is a key-value store system, and wherein routing the target request to the target storage instance comprises:
acquiring a target key in the target request,
acquiring, at the target computing node, a routing rule used for performance of the second routing, wherein the routing rule is defined by the target application, and
routing, based on the target key at the target computing node, the target request to the target storage instance by means of the routing rule.

13. The device of claim 10, wherein the target computing node maintains a shared pre-write log and a shared memory table shared by sub shards in the hosted logical shard.

14. The device of claim 13, wherein the actions further comprise, in response to determining that the target request is a write request,:
writing target data in the target request into the shared pre-write log, and
recording the target storage instance to which the target request is to be routed into the shared pre-write log.

15. The device of claim 14, wherein the actions further comprise:
in response to determining that the target data is written into the shared pre-write log, writing the target data into the shared memory table; and
in response to determining that the shared memory table reaches a reserved storage size, executing a dumping operation, wherein the dumping operation is configured to write to-be-dumped data in the shared memory table into a corresponding storage instance maintained by the target computing node.

16. The device of claim 15, wherein the actions further comprise:
determining, based on the routing rule used for performing the second routing, a storage instance into which the to-be-dumped data in the shared memory table will be written; and
dumping the to-be-dumped data into the corresponding storage instance in parallel.

17. The device of claim 13, wherein the actions further comprise, in response to determining that the target request is an atomic batch request:
writing the atomic batch request into the shared pre-write log in batches, and
in response to determining that the atomic batch request is written into the shared pre-write log, writing the atomic batch request in batches into the shared memory table.

18. (canceled)

19. A computer program product, the computer program product being stored on a non-transitory computer-readable medium and comprising machine-executable instructions, wherein the machine-executable instructions, when executed, cause a machine to perform operations, comprising:
receiving a target request from a target application, wherein the target request is determined, at the target application through a first routing, to be routed to a target computing node in multiple computing nodes on a storage system, and each computing node in the multiple computing nodes hosts a corresponding logical shard;
routing the target request to a target storage instance by performing a second routing on the target request at the target computing node, wherein the target storage instance corresponds to a sub shard in the logical shard hosted by the target computing node; executing a storage operation corresponding to the target request at the target storage instance; and
in response to determining that an original storage instance maintained by a computing node in the multiple computing nodes will be expanded.
initializing multiple newly created storage instances, wherein the multiple newly created storage instances have a same type of storage structure as the original storage instance,
migrating, by traversing key-value pairs in the original storage instance, the key-value pairs to the multiple newly created storage instances,
during the migration, executing a dual-write operation on the written key-value pairs, and
in response to determining that the migration has ended, switching the computing node from maintaining the original storage instance to maintaining the multiple newly created storage instances.

20. The computer program product of claim 19, wherein the storage system is a key-value store system, and wherein the target request is determined, at the target application through the first routing, to be routed to the target computing node comprises:
acquiring, via the storage system from the target application, a target key in the target request, and
routing, via the storage system using a consistent hashing process based on the target key, the target request to the target computing node in the multiple computing nodes.

21. The computer program product of claim 19, wherein the target computing node maintains a shared write ahead log (WAL) and a shared memory table shared by sub shards in the hosted logical shard.

22. The computer program product of claim 21, wherein the operations further comprise:
in response to determining that the target request is a write request,
writing target data in the target request into the shared WAL, and
recording, into the shared WAL, the target storage instance to which the target request is to be routed.
